(19) United States
(12) Patent Application Publication
(10) Pub. No.: US 2017/0370316 A1
(43) Pub. Date: Dec. 28, 2017

(54) METHOD FOR KNOCK CONTROL IN AN INTERNAL COMBUSTION ENGINE

(71) Applicant: MTU FRIEDRICHSHAFEN GMBH, Friedrichshafen (DE)

(72) Inventors: Johannes BAUER, Hellerndorf (DE); Tim SPÄDER, Langenargen (DE)

(21) Appl. No.: 15/543,844

(22) PCT Filed: Jun. 2, 2016
(86) PCT No.: PCT/EP2016/000898

§ 371 Date: Jul. 14, 2017

(30) Foreign Application Priority Data
Jun. 10, 2015 (DE) 10 2015 007 368.0

(51) Int. Cl. F02D 41/14; F02D 35/02; F02D 41/00; F02D 41/40

(52) U.S. Cl. CPC F02D 41/1498; F02D 41/40; F02D 35/027; F02D 41/0027; F02D 41/0082

(57) ABSTRACT

A method for carrying out the operation of an internal combustion engine, wherein liquid fuel injection amounts are injected at cylinders of a group of cylinders of the internal combustion engine in the context of injection events, wherein in a first step, a first cylinder of the group with the strongest knocking tendency over a time period is determined, and in a second step an injection correction occurs such that the injection events at the first determined cylinder can be sequentially reduced in their injection duration or injection amount by a first correction value, while the injection duration or injection amount of the injection events at the other cylinders of the group are sequentially increased by a second correction value.

The present invention is based on a method for carrying out the operation of a combustion engine according to the preamble of claim 1.

With combustion engines that use standard diesel injectors, there is often the problem that said injectors provide different amounts, even if small injection amounts are to be precisely applied. This results mainly from operation in the ballistic region, which is associated with very short energizing durations.

When using the injectors in BiFuel environments, in which added gas is to be ignited by means of small injection amounts, it can thus occur that different amounts of ignition energy are provided to the cylinders for the ignition of the gas mixture, resulting in different combustion profiles. Whereas, owing to the relatively higher ignition energy for example, individual cylinders burn very rapidly and hence in the knocking combustion region, other cylinders are still significantly far from the ignition limit, for example because one injector injects and the other does not inject despite the same energizing duration. As it absolutely must be avoided that unburnt gas passes through the cylinder and into the exhaust system or the environment, disadvantageously a safety separation from the minimum injection amount or duration is necessary.

Based on this, it is the object of the present invention to specify a method that enables improved and more efficient operation of a combustion engine.

This object is achieved with a method with the features of claim 1.

Advantageous developments and embodiments of the invention are stated in the further claims.

A method for carrying out the operation of a combustion engine, preferably a BiFuel combustion engine, is proposed according to the invention. The combustion engine can in general be a combustion engine of the diesel type for example, but preferably a BiFuel combustion engine, which in addition to liquid fuel operation (with diesel fuel, also with heavy oil or bio oil, for example) also provides operation with combustion gas, for example in the context of dual fuel operation, wherein a small feed amount of diesel fuel is provided for the ignition of the gas mixture. The method is preferably carried out for example with a combustion engine in the form of a large engine, for example as provided in a motor vehicle such as a ship, a commercial vehicle or special vehicle, or for example for a stationary device, for example for a combined heat and power station, an (emergency) power unit, and for example also for industrial applications.

With the method, liquid fuel injection amounts are injected into cylinders of a group of cylinders of the combustion engine, preferably directly into the respective combustion chamber of a cylinder, for which in particular liquid fuel-injectors are provided, furthermore for example standard diesel injectors. The injection of the liquid fuel injection amounts is carried out during—discrete—injection events, wherein the control of the injection events for example is carried out by an injection controller, for example implemented in a control unit of the combustion engine. Furthermore, in the context of the present invention a group of cylinders can refer to the cylinders of a bank of cylinders of the combustion engine, for example comprising a number of cylinders of the order of magnitude between preferably 6 and 12 cylinders.

In the manner characterizing the invention, with the method in a first step a first cylinder of the group is determined that has the highest tendency to knocking, i.e. that knocks the most, in particular over a period of time (of observation). In particular, the knocking intensity is observed in this respect.

To determine said cylinder, with the invention a knock sensing arrangement is provided that is suitable for detecting knocking at a respective cylinder of the group (the knocking is frequently accompanied by typical, high-frequency vibration components or knocking noise). Such a knock sensing arrangement is preferably formed by a number of sensors of sound in solids, alternatively or additionally for example by a number of cylinder pressure sensors. The knock sensing arrangement can be implemented by means of one or more knock modules on the combustion engine.

In order to identify or to determine the greatest knocking cylinder or the cylinder with the greatest tendency to knocking, the signals of the knock sensing arrangement can be analyzed in order to obtain the relevant information. It is preferably provided in the context of the present invention that the determination of the greatest knocking cylinder is carried out by means of a knock controller of the combustion engine or by taking into account knock control.

For this purpose, signals of the knock sensing arrangement, and in this respect knock information, are preferably fed to such a knock controller that is configured according to the invention, based on which the knock controller adjusts the beginning of injection, and therefore the ignition time point, of the respective cylinder. As in connection with such control of the beginning of injection (BOI: beginning of injection) knocking cylinders are frequently set to “late”, for the determination of the greatest knocking cylinder—over the time period—it is proposed in the context of the invention to extract or evaluate beginning of injection information from the knock controller in an advantageous and inexpensive manner.

Insofar as the latest beginning of injection is correlated with the greatest tendency to knocking—from the knock controller—for determination of that first cylinder with the greatest tendency to knocking, preferably an average value of the beginning of injection of a respective cylinder of the group is compared with a beginning of injection average value that is determined across all cylinders of the group (wherein the average values in particular are each determined over the time period), and the cylinder that has the most significant deviation from the beginning of injection average value of all the cylinders, i.e. towards “late”, is determined as the one with the greatest tendency to knocking. Respective average values can advantageously be simply obtained and evaluated during this as (beginning of injection) information by the knock controller.

Following the determination of the first cylinder with the—over the time period—greatest tendency to knocking, with the method according to the invention an injection correction is now carried out in a second step, in that the injection events at the first determined cylinder each subsequently decrease in injection duration or injection amount by a first correction amount, whereas the injection duration or injection amount of the injection events at the other cylinders of the group are subsequently increased by a second correction amount.

With the proposed method, it is thus advantageously possible to correct or reduce the tendency to knocking of a most strongly knocking cylinder by reducing the amount of energy imparted by the injection events by using the first correction amount. Furthermore, the other slower burning cylinders are supplied with more energy (duration/amount) during the corrected injection events—by the addition of the second correction amounts—so that the same burn more efficiently. This advantageously enables an operating state to be achieved in which the tendency to knocking of all cylinders is equalized or similar, and therefore more efficient operation of the combustion engine is achieved. The method is preferably carried out with the injection of small or very small injection amounts of liquid fuel, in particular as high scattering of the already mentioned type with reference to a dosing accuracy of the injectors is to be expected in this case, furthermore especially in the context of the implementation of the method with a BiFuel operation.

Note that the (observation) time period within which the cylinder with the greatest tendency to knocking is determined can be freely selected. However, a time period of up to several minutes is proposed, so that before the injection correction in the second step (amount/duration) it can be ensured that the first determined cylinder is liable to knocking permanently and not only sporadically.

Furthermore, note that with the method it is provided only to correct or change the injection amount or injection duration of the injection events in the second step, but not the beginning of injection (of a respective engine working cycle)—preferably predetermined by the knock control. Thus, the mutual influences of a control device correcting the injection events according to the method, preferably formed by an injection controller, and the knock controller are advantageously low.

In an advantageous development of the invention, it is furthermore provided to use the method in a suitable manner subsequently for yet another cylinder of the group. Here a second cylinder of the respective group with the next greatest or second greatest tendency to knocking over the time period can be determined in a third step. For the determination of the further cylinder, the second greatest average value deviation over the time period can be used, wherein average values of the first step (of an individual cylinder and all cylinders) are preferably determined over the time period (injection start), are observed again and are examined regarding the second greatest deviation (in the direction towards “late”). The first cylinder need not be considered here.

In a fourth step, a further injection correction can now be carried out to the effect that the injection events at the second determined cylinder that has already been injection-corrected in the second step are subsequently each reduced in injection duration or injection amount by a third correction amount, whereas the injection duration or injection amount of the injection events at the further cylinders of the group that were injection-corrected in the second step—with the exception of the first cylinder—are each subsequently increased by a fourth correction amount. In other words, the first, already corrected cylinder is not corrected again with the third and fourth steps, but the others are.

Regarding the further design of the third and fourth steps, we additionally refer to the previous statements for the first and second steps, which can apply similarly for this purpose. With completion of the above, a further improvement regarding synchronization of the cylinders of the combustion engine is again achieved.

Following the execution of the second step and before the fourth step, a waiting time is preferably waited for. Within the waiting time, control, in particular knock control, can settle, so that no system instabilities can occur. The waiting time can be parameterized, for example can be one to several minutes.

In general, it is furthermore provided with the invention that the first or third correction amount in the second or fourth step corresponds to a predetermined offset, in particular to a subsequently constant offset over the injection events. Furthermore, such an offset is preferably identical for the second and fourth steps. Regarding the reduction of the injection duration, an offset can be 10 μs to 100 μs for example, preferably 20 μs for example (wherein by comparison the unreduced injection duration can lie in the region from 500 μs to 700 μs for example, preferably at approx. 600 μs).

Analogous to this, it is also the aim that the second and fourth correction amounts are equal across the cylinders on which they are used. Here, a respective second correction amount preferably corresponds to the first correction amount divided by the number of the further cylinders, furthermore a respective fourth correction amount preferably corresponds to the third correction amount divided by the number of further cylinders reduced by the first cylinder. In other words, it is provided that the amount of energy that can be extracted at the cylinders with the greatest knocking (the first and/or the second) in the context of the reduction, is added to the further cylinders in equal proportions, so that the amount of energy remains the same in total across all cylinders with the method, i.e. the average value across all cylinders with regard to the injection amount or injection duration advantageously does not change owing to the injection correction according to the method. The engine power can thus remain unchanged.

The (injection) correction according to the second or fourth step of the method can be maintained—during subsequent injection events—until a criterion for termination is met, for example a period has elapsed, the method is for example performed again or a change in the operating mode of the combustion engine is envisaged, for example from BiFuel operation to single-fuel operation.

With a combustion engine, which in addition to a first group of cylinders, in particular a first bank of cylinders, also has a second group of cylinders, in particular a second bank of cylinders, it is provided that the method as discussed above is carried out with the first group and separately therefrom with the second group. This enables banks of cylinders to be corrected mutually independently, whereby implementation of the method is simplified, in particular as differences between a first and second bank of cylinders are often to be expected with regards to average pressure and asymmetries (concerning the camshaft).

With the invention, a combustion engine, in particular a BiFuel combustion engine, is also proposed that is designed to carry out the method as discussed above.

Further features and advantages of the invention are revealed in the following description of exemplary embodiments of the invention, using the figures of the drawings, which show significant invention details, and from the claims. The individual features can each be implemented for a version of the invention individually or in various combinations.

Preferred embodiments of the invention are described in detail below using the accompanying drawings. In the figures:

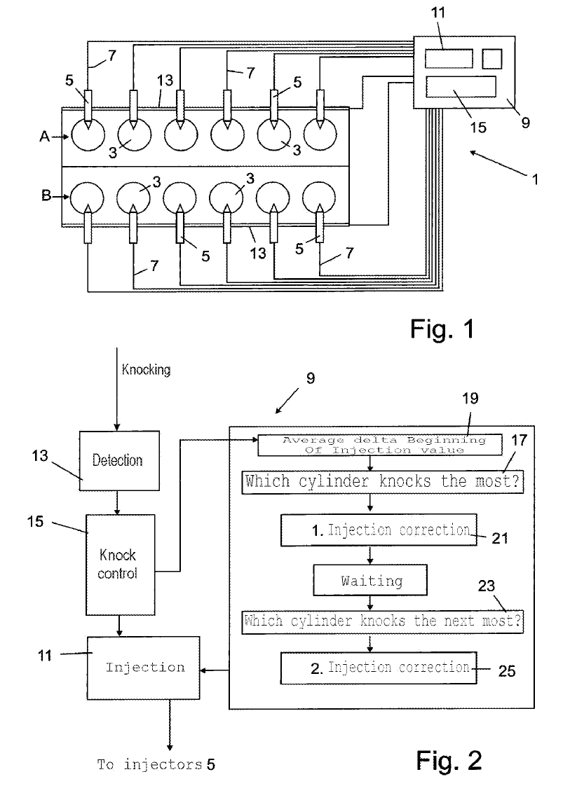

FIG. 1 shows schematically an example of a combustion engine for carrying out the method according to the invention.

FIG. 2 shows schematically an example of a structure diagram for illustrating the method according to the invention according to a possible embodiment of the invention.

In the following description and the drawings, identical reference characters correspond to elements with identical or comparable functions.

FIG. 1 shows schematically an example of a combustion engine 1 with a first group of cylinders 3, i.e. a bank of cylinders A and a second group of cylinders 3, i.e. a bank of cylinders B, which by way of example each comprise six cylinders 3. The combustion engine 1 is designed here for BiFuel operation with liquid fuel and combustion gas, besides which single-fuel operation can be provided with liquid fuel alone. Diesel fuel is preferably used as liquid fuel, for example natural gas, biogas or synthesis gas is used as combustion gas.

For the injection of the liquid fuel at the cylinders 3, in particular in combustion chambers of the cylinders 3, a liquid fuel or diesel injector 5, which for example can be supplied with liquid fuel via a common rail or even a single pressure reservoir (not shown), is associated with a respective cylinder 3. A respective injector 5 is actuated via a control line 7, which is connected to a control device 9 of the combustion engine 1, which comprises an injection controller 11. The control device 9 can be formed by means of one or more control units of the combustion engine 1, for example even with dislocated function units/control units.

A knock sensing arrangement 13 is disposed on the cylinders 3 of a respective bank A, B, which obtains knock signals cylinder-specifically and delivers the signals to a knock controller 15, which knock controller 15 can preferably be part of the control device 9. The knock sensing arrangement 13 can be formed by means of a number of sound in solids sensors and/or cylinder pressure sensors.

FIG. 2 illustrates the control device 9 for process control in more detail. Knocking of respective cylinders 3, which causes high-frequency oscillations, is detected by the sensors of the knock sensing arrangement 13 and transmitted as a knock signal to the knock controller 15. Based on this, in collaboration with the injection controller 11 the knock controller 15 adjusts the injection operation, i.e. respective injection events, of a respective cylinder 3. In said working association, the beginning of injection (BOI: beginning of injection) is predetermined by the knock controller 13 adjusted towards “late”, for example knocking noise is no longer detected up to the respective knocking cylinder 3.

As FIG. 2 shows furthermore, the combustion engine 1 or the control device 9 comprises still further functionality. In order to determine in a first step 17 of the method a first cylinder 3 of the respective bank of cylinders or group A, B having the greatest tendency to knocking over a time period, the control device 9 compares a beginning of injection average value of respective cylinders 3 with a beginning of injection average value of all cylinders 3 of the group A or B, ref. char. 19, the average values each being determined in particular over the time period.

Based on said beginning of injection information, which is provided by the knock controller 15, the cylinder 3 with the beginning of injection average value with the largest deviation—towards late adjustment of the beginning of injection—from the average value of all cylinders 3, i.e. when observed over the time period, is determined by the control unit 9 as having the greatest tendency to knocking, i.e. in the context of the first step of the method 17. The observation time period is selected in this case so that only sporadically occurring knocking does not matter. A selected time period of several minutes has been shown to be advantageous.

In a subsequent second step of the method 21, an injection correction is now carried out on the cylinders 3 of the group A or B to the effect that the injection events at the first determined cylinder 3 are each subsequently reduced or corrected downwards in injection duration or injection amount, i.e. in amount of energy, by a first correction amount, whereas the injection duration or injection amount, i.e. the amount of energy, of the injection events at the further cylinders 3 of the group A or B is subsequently increased or corrected upwards by a second correction amount.

The injection events, which are now all subjected to correction, are correspondingly controlled by means of the control device 9 via the injection controller 11, i.e. the injectors 5 are now energized based on the demand for the injection amount or duration corrected according to the method, but the beginning of injection (BOI) continues to be relevant according to the knock controller 15. In particular, a reduction by a predetermined first correction amount or offset correction amount, which furthermore remains constant, is provided in this context.

With regard to the increase of the injection duration or injection amount by the second correction amount at the further cylinders 3, the energy input is increased proportionately by the second correction amount and in particular to the same extent, in this case in particular by an amount corresponding to the value of the first correction amount divided by the number of further cylinders 3.

By way of example, with the second step 21 of the method a reduction of the injection duration of each subsequent injection event by a first correction amount of 20 μs for the first cylinder 3 can be provided (in the case of an injection duration of for example 600 μs that is not reduced by comparison and an injection pressure of for example 800 bar), wherein the five further cylinders 3 each subsequently undergo a correction of the injection duration in the sense of an increase of the injection duration with a second correction amount of 4 μs (20 μs divided by the number of cylinders (5)).

In the context of the injection events corrected in this way, the amount of energy at the previously knocking cylinder 3 is successfully reduced and the amount of energy at the poorly combusting cylinder 3 is successfully increased, so that an improved equalization of the cylinders 3 with regard to the combustion process is achieved. The method is hereby carried out separately for the first bank of cylinders A and second bank of cylinders B, so that a very precise correction can be carried out.

In a development of the method, it is optionally (but preferably) provided, following the first correction according to the first step 17 and second step 21 of the method, to carry out a further correction at a respective bank of cylinders A or B that includes a third step 23 and a fourth step 25 of the method. As with the first step 17 and the second step 21 of the method, in this case in the third step of the method 23 a cylinder 3, the second cylinder 3 of the respective group A or B is now determined that has the next greatest or second greatest tendency to knocking over the time period. For this purpose, the beginning of injection information provided on the part of the knock controller 15 is preferably reused (besides which a new determination can also be provided, however) and based thereon the cylinder 3 that has the second highest average value deviation towards “late” is determined as having the second greatest tendency to knocking.

Analogously to the second step 21, a further injection correction is then carried out in the fourth step 25 to the effect that the injection events at the second determined cylinder 3—which have already been injection-corrected in the second step 21—are each subsequently reduced or corrected downwards in injection duration or injection amount by a third correction amount, whereas the injection duration or injection amount of the injection events at the further cylinders 3 of the group A or B—with the exception of the first cylinder 3—which have also already been injection-corrected in the second step—are each subsequently increased or corrected upwards by a fourth correction amount.

With the fourth step, the third correction amount preferably corresponds to the first correction amount of the second step, for example the offset of 20 μs. By contrast, the fourth correction amount for the further cylinders 3, i.e. the third to sixth cylinders 3, is however greater compared to the second correction amount. With the selected example, this is for example determined according to: third correction amount (20 μs) divided by the number of further cylinders (5) reduced by a (first) cylinder, i.e. 20 μs/4=5 μs.

Following the second correction according to the third 23 and fourth 25 steps of the method, subsequent injection events are then controlled and correspondingly subject to correction, wherein again the beginning of injection according to the knock controller 15 is used as the basis, but the newly corrected injection duration or amount is introduced. In this respect, with the injection correction (with the fourth step) illustrated by way of example, the injection events for the first cylinder 3 are now reduced in duration by 20 μs, for the second cylinder by 16 μs, whereas the injection events of the third to sixth cylinders 3 are each extended in duration by 9 μs.

Furthermore, between the first injection correction according to the first 17 and second 21 steps of the method and the second injection correction according to the third 23 and fourth 25 steps of the method, a waiting time or waiting phase is inserted, which is used to enable settling of the knock controller 15, which now controls taking into account the corrected injection events.

It is conceivable to execute the method only with steps 1 and 2, but in addition to also carry out the steps of the method similarly for a third or fourth cylinder 3 of the respective group A or B, wherein such a procedure is only proposed for a number of cylinders greater than six per group A or B. In general, the method is preferably only provided for short injection durations (about 600 μs) and furthermore only for BiFuel operation. The injection corrections according to the method can often be reset at the start of the BiFuel mode (initialization).

### REFERENCE CHARACTER LIST

| | |
|---|---|
| 1 | combustion engine |
| 3 | cylinder |
| 5 | injector |
| 7 | control line |
| 9 | control device |
| 11 | injection controller |
| 13 | knock sensing arrangement |
| 15 | knock control |
| 17 | first step of the method |
| 19 | average value comparison |
| 21 | second step of the method |
| 23 | third step of the method |
| 25 | fourth step of the method |
| A, B | bank (group) |

1-10. (canceled)

11. A method for carrying out operation of a combustion engine, wherein liquid fuel-injection amounts are injected at cylinders of a group of cylinders of the combustion engine during injection events; the method comprising the steps of:
in a first step, determining a first cylinder of the group that has a greatest tendency to knocking over a time period; and
in a second step, carrying out an injection correction so that injection events at the first determined cylinder are each subsequently reduced in injection duration or injection amount by a first correction amount, whereas the injection duration or injection amount of the injection events at further cylinders of the group are each subsequently increased by a second correction amount.

12. The method according to claim 11, further including
in a third step of determining a second cylinder of the group that has a next greatest tendency to knocking over the time period; and
in a fourth step, carrying out a further injection correction so that the injection-corrected injection events determined at the second cylinder with the second step are each subsequently reduced in injection duration or injection amount by a third correction amount, whereas the injection duration or injection amount of the injection events injection-corrected with the second step at the further cylinders of the group, with the exception of the first cylinder, are each subsequently increased by a fourth correction amount.

13. The method according to claim 12, wherein
the respective correction amount for the reduction in the second or fourth step corresponds to a predetermined offset; and/or
a respective second correction amount corresponds to the first correction amount divided by the number of further cylinders; and/or a respective fourth correction amount corresponds to the third correction amount divided by the number of further cylinders reduced by one, the first cylinder.

14. The method according to claim 12, wherein
a waiting time is waited for between the second step and the fourth step; and/or
the first correction amount equals the third correction amount.

15. The method according to claim 11, including using
beginning of injection information from a knock controller of the combustion engine for determination of the first or second cylinder.

16. The method according to claim 11, including carrying out
the method with BiFuel operation of the combustion engine, wherein in addition to the liquid fuel, combustion gas is also dispensed to the cylinder.

17. The method according to claim 11, including carrying out
the method with injection durations in a range of 500 μs to 700 μs and/or an injection pressure of about 800 bar; or
the method with an injection of small amounts or very small amounts.

18. The method according to claim 11, wherein liquid fuel injection amounts are injected at cylinders in a first and a second group of cylinders of the combustion engine, wherein the method is carried out with the first group and separately therefrom with the second group.

19. The method according to claim 11, including determining
the greatest tendency to knocking by comparing a beginning of injection average value of a respective cylinder of a group with a beginning of injection average value across all cylinders of the respective group;
the cylinder with the beginning of injection average value with the greatest deviation from the beginning of injection average value of all cylinders of the group being determined as the cylinder with the greatest tendency to knocking.

20. A combustion engine, designed for carrying out the method according to claim 11.
